(19) United States
(12) Patent Application Publication
(10) Pub. No.: US 2014/0207765 A1
(43) Pub. Date: Jul. 24, 2014

(54) DYNAMIC FEATURE SELECTION WITH MAX-RELEVANCY AND MINIMUM REDUNDANCY CRITERIA

(71) Applicant: International Business Machines Corporation, Armonk, NY (US)

(72) Inventors: David HAWS, New York, NY (US); Dan HE, Ossining, NY (US); Laxmi P. PARIDA, Mohegan Lake, NY (US)

(73) Assignee: INTERNATIONAL BUSINESS MACHINES CORPORATION, Armonk, NY (US)

(21) Appl. No.: 14/030,720

(22) Filed: Sep. 18, 2013

Related U.S. Application Data
(63) Continuation of application No. 13/745,923, filed on Jan. 21, 2013.

(51) Int. Cl. G06F 17/30

(52) U.S. Cl. CPC G06F 17/3053
USPC 707/723

(57) ABSTRACT

Various embodiments select features from a feature space. In one embodiment a set of features and a class value are received. A redundancy score is obtained for a feature that was previously selected from the set of features. A redundancy score is determined, for each of a plurality of unselected features in the set of features, based on the redundancy score that has been obtained, and a redundancy between the unselected feature and the feature that was previously selected. A relevance to the class value is determined for each of the unselected features. A feature from the plurality of unselected features with a highest relevance to the class value and a lowest redundancy score is selected.

### CROSS-REFERENCE TO RELATED APPLICATIONS

This application is based upon and claims priority from prior U.S. patent application Ser. No. 13/745,923, filed on Jan. 21, 2013, now U.S. patent Ser. No. ______, the entire disclosure of which is herein incorporated by reference in its entirety.

### BACKGROUND

The present invention generally relates to the field of feature selection, and more particularly relates to dynamic feature selection with Max-Relevancy and Min-Redundancy criteria.

Feature selection methods are critical for classification and regression problems. For example, it is common in large-scale learning applications, especially for biology data such as gene expression data and genotype data, that the amount of variables far exceeds the number of samples. The “curse of dimensionality” problem not only affects the computational efficiency of the learning algorithms, but also leads to poor performance of these algorithms. To address this problem, various feature selection methods can be utilized where a subset of important features is selected and the learning algorithms are trained on these features.

### BRIEF SUMMARY

In one embodiment, a computer implemented method for selecting features from a feature space is disclosed. The computer implemented method includes receiving, by a processor, a set of features and a class value are received by a processor. A redundancy score is obtained for a feature that was previously selected from the set of features. A redundancy score is determined, for each of a plurality of unselected features in the set of features, based on the redundancy score that has been obtained, and a redundancy between the unselected feature and the feature that was previously selected. A relevance to the class value is determined for each of the unselected features. A feature from the plurality of unselected features with a highest relevance to the class value and a lowest redundancy score is selected.

In another embodiment, an information processing system for selecting features from a feature space is disclosed. The information processing system includes a memory and a processor that is communicatively coupled to the memory. A feature selection module is communicatively coupled to the memory and the processor. The feature selection module is configured to perform a method. The method includes receiving, by a processor, a set of features and a class value are received by a processor. A redundancy score is obtained for a feature that was previously selected from the set of features. A redundancy score is determined, for each of a plurality of unselected features in the set of features, based on the redundancy score that has been obtained, and a redundancy between the unselected feature and the feature that was previously selected. A relevance to the class value is determined for each of the unselected features. A feature from the plurality of unselected features with a highest relevance to the class value and a lowest redundancy score is selected.

In a further embodiment, a computer program product for selecting features from a feature space is disclosed. The computer program product includes a non-transitory storage medium readable by a processing circuit and storing instructions for execution by the processing circuit for performing a method. The method includes receiving, by a processor, a set of features and a class value are received by a processor. A redundancy score is obtained for a feature that was previously selected from the set of features. A redundancy score is determined, for each of a plurality of unselected features in the set of features, based on the redundancy score that has been obtained, and a redundancy between the unselected feature and the feature that was previously selected. A relevance to the class value is determined for each of the unselected features. A feature from the plurality of unselected features with a highest relevance to the class value and a lowest redundancy score is selected.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention, in which:

FIG. 1 is a block diagram illustrating one example of an operating environment according to one embodiment of the present invention; and

FIG. 2 is an operational flow diagram illustrating one example of selecting features from a feature space according to one embodiment of the present invention.

### DETAILED DESCRIPTION

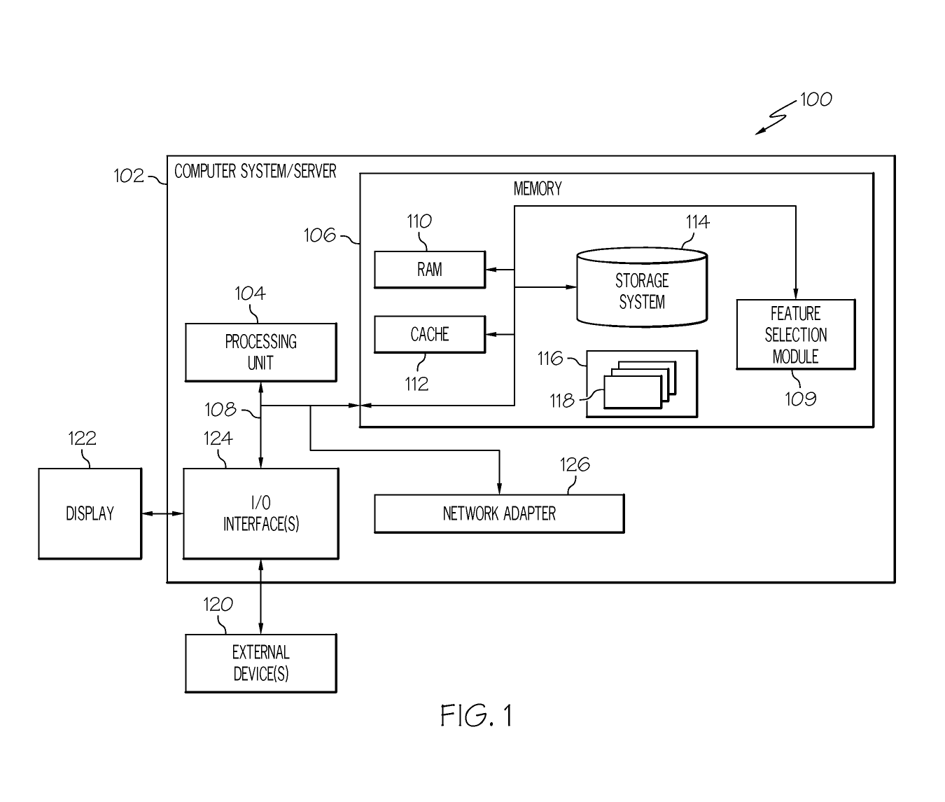

FIG. 1 illustrates a general overview of one operating environment 100 according to one embodiment of the present invention. In particular, FIG. 1 illustrates an information processing system 102 that can be utilized in embodiments of the present invention. The information processing system 102 shown in FIG. 1 is only one example of a suitable system and is not intended to limit the scope of use or functionality of embodiments of the present invention described above. The information processing system 102 of FIG. 1 is capable of implementing and/or performing any of the functionality set forth above. Any suitably configured processing system can be used as the information processing system 102 in embodiments of the present invention.

As illustrated in FIG. 1, the information processing system 102 is in the form of a general-purpose computing device. The components of the information processing system 102 can include, but are not limited to, one or more processors or processing units 104, a system memory 106, and a bus 108 that couples various system components including the system memory 106 to the processor 104.

The bus 108 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The system memory 106, in one embodiment, includes a feature selection module 109 configured to perform one or more embodiments discussed below. For example, in one embodiment, the feature selection module 109 is configured to select a set of features from a feature space using a dynamic Max-Relevance and Min-Redundancy (DMRMR) selection process, which is discussed in greater detail below. It should be noted that even though FIG. 1 shows the feature selection module 109 residing in the main memory, the feature selection module 109 can reside within the processor 104, be a separate hardware component capable of e, and/or be distributed across a plurality of information processing systems and/or processors.

The system memory 106 can also include computer system readable media in the form of volatile memory, such as random access memory (RAM) 110 and/or cache memory 112. The information processing system 102 can further include other removable/non-removable, volatile/non-volatile computer system storage media. By way of example only, a storage system 114 can be provided for reading from and writing to a non-removable or removable, non-volatile media such as one or more solid state disks and/or magnetic media (typically called a “hard drive”). A magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 108 by one or more data media interfaces. The memory 106 can include at least one program product having a set of program modules that are configured to carry out the functions of an embodiment of the present invention.

Program/utility 116, having a set of program modules 118, may be stored in memory 106 by way of example, and not limitation, as well as an operating system, one or more application programs, other program modules, and program data. Each of the operating system, one or more application programs, other program modules, and program data or some combination thereof, may include an implementation of a networking environment. Program modules 118 generally carry out the functions and/or methodologies of embodiments of the present invention.

The information processing system 102 can also communicate with one or more external devices 120 such as a keyboard, a pointing device, a display 122, etc.; one or more devices that enable a user to interact with the information processing system 102; and/or any devices (e.g., network card, modem, etc.) that enable computer system/server 102 to communicate with one or more other computing devices. Such communication can occur via I/O interfaces 124. Still yet, the information processing system 102 can communicate with one or more networks such as a local area network (LAN), a general wide area network (WAN), and/or a public network (e.g., the Internet) via network adapter 126. As depicted, the network adapter 126 communicates with the other components of information processing system 102 via the bus 108. Other hardware and/or software components can also be used in conjunction with the information processing system 102. Examples include, but are not limited to: microcode, device drivers, redundant processing units, external disk drive arrays, RAID systems, tape drives, and data archival storage systems.

One criterion for feature selection is referred to as Maximum-Relevance and Minimum-Redundancy (MRMR). In MRMR the selected features should be maximally relevant to the class value, and also minimally dependent on each other. In MRMR, the Maximum-Relevance criterion searches for features that maximize the mean value of all mutual information values between individual features and a class variable. However, feature selection based only on Maximum-Relevance tends to select features that have high redundancy, namely the correlation of the selected features tends to be high. If some of these highly correlated features are removed the respective class-discriminative power would not change, or would only change by an insignificant amount. Therefore, the Minimum-Redundancy criterion is utilized to select mutually exclusive features. A more detailed discussion on MRMR is given in Peng et al., “Feature selection based on mutual information criteria of max-dependency, max-relevance, and min-redundancy”, Pattern Analysis and Machine Intelligence, IEEE Transactions on, 27(8): 1226-1238, 2005, which is hereby incorporated by reference in its entirety.

Conventional feature selection mechanisms based on MRMR generally utilize an incremental search to effectively find the near-optimal features. Features are selected in a greedy manner to maximize an objective function defined based on Maximum-Relevance and Minimum-Redundancy. However, this conventional greedy algorithm is generally not efficient in that for every candidate feature, in order to compute the new redundancy when the feature is included, the mutual information between all the previously selected features needs to be recomputed.

Therefore, one or more embodiments provide a dynamic MRMR (DMRMR) feature selection mechanism that utilizes dynamic programming to minimize redundancy computations. For example, DMRMR computes the redundancy of a candidate feature from the previously computed redundancy (i.e., the current redundancy) of the previously selected feature. This is based on the difference between the new redundancy and the current redundancy being the mutual information between the candidate feature and the previously selected features. Therefore, redundant computations for the mutual information between all the previously selected features can be avoided. The time complexity of DMRMR is N times faster than the greedy algorithm utilized by conventional MRMR methods, where N is the number of features selected.

In one embodiment, the feature selection module 109 receives as input a set of training samples, each including a set of features such as and a class/target value. The feature selection module 109 also receives a set of test samples, each including only the same set of features as the training samples, but with target values missing. In one embodiment, features can be represented as rows and samples as columns. Therefore, the training and test datasets comprise the same columns (features), but different rows (samples). The number of features to be selected is also received as input by the feature selection module 109.

It should be noted that in other embodiments the test samples are not received, and the HMRMR selection process is only performed on the training samples. Based on these inputs, the feature selection module 109 performs a DMRMR feature selection process to select a set of features from the feature set S. If test samples are also provided as input to the feature selection module 109, the selected set of features can be further processed to build a model to predict the missing target values of the test samples.

In particular, the feature selection module 109 maintains two pools of features, one pool for selected features (referred to herein as the “SF pool”), and one pool for the remaining unselected features (referred to herein as the “UF pool”). The UF pool initially includes all the features from the training samples, while the SF pool is initially empty. In this embodiment, features are incrementally selected from input feature set(s) in a greedy way while simultaneously optimizing the following Maximum-Relevancy and Minimum-Redundancy conditions:

$$\begin{matrix}\begin{matrix}max D ( S , c ) , & D = \frac{1}{\vert S \vert} {\sum }_{{x}_{i ∈ S}} I ( {x}_{i} ; c )\end{matrix} & ( EQ 1 ) \\ \begin{matrix}min R ( S ) , & R = \frac{1}{{\vert S \vert}^{2}} {\sum }_{{x}_{i} , {x}_{j ∈ S}} I ( {x}_{i} ; {x}_{j} ) ,\end{matrix} & ( EQ 2 )\end{matrix}$$

where S is a feature set, xᵢ is the ith feature in S, xⱼ is the jth feature in S, and I is mutual information.

For example, each feature selected from the set of features S has the largest mutual information with the target class c, and minimizes the redundancy of the feature with all the selected features in the SF pool, i.e., the sum of mutual information I between the mth selected feature xₘ and previously selected features xᵢ(i=1, . . . , m−1) is minimized. Mutual information I of two variables x and y can be defined, based on their joint marginal probabilities p(x) and p(y) and probabilistic distribution p(x, y), as:

$$I ( x , y ) = {\sum }_{i , j} p ( {x}_{i} , {y}_{i} ) log \frac{p ( {x}_{i} , {y}_{i} )}{p ( {x}_{i} ) p ( {y}_{i} )} . \qquad ( EQ 3 )$$

It should be noted that other methods for determining the mutual information I of variables can also be used.

In one embodiment, when selecting the first feature from the set of unselected features the feature selection module 109 determines an MRMR score for each unselected feature according to:

$${score ( {x}_{j} )}_{m} = [ I ( {x}_{j} ; c ) - \frac{1}{m - 1} {\sum }_{{x}_{i} ∈ {S}_{m - 1}} I ( {x}_{j} ; {x}_{i} ) ] , \qquad ( EQ 4 )$$

where EQ 4 gives the MRMR score. The feature with the maximum MRMR score is then selected. It should be noted that for the first selected feature a redundancy calculation is not required since no other features have been selected. Therefore, the MRMR score of the first selected feature is only based on the relevance the relevance I(xⱼ; c) of the first selected feature

score(xⱼ)₁=(I(xⱼ;c)) (EQ 5).

The remaining features are selected in an incremental fashion. For example, if m−1 features have already been selected for the set S, the set S includes m−1 features. The task is to select the mth feature from the set {X−Sₘ₋₁}, where X is all of the features (i.e., the input set of features) according to EQ 4. The final set of selected features approximately optimizes EQ 1 and 2.

When selecting subsequent features not only is Max-Relevancy (EQ 1) considered, but also Min-Redundancy (EQ 2). In one embodiment, the feature selection module 109 determines the redundancy of subsequently selected features using a dynamic programming strategy such that the new redundancy can be computed from the current redundancy. This DMRMR process takes advantage of the fact that the new redundancy and the current redundancy are only different by the mutual information between the candidate feature and the feature selected in the previous step. Therefore redundant computations for the mutual information between all the previously selected features can be avoided.

For example, the feature selection module 109 determines redundancy according to the current MRMR score based on the following:

$$\begin{matrix}{redundancy}^{′} = ( I ( {x}_{j} \text{:} c ) - {score ( {x}_{j} )}_{m - 1} ) \times ( m - 2 ) , & ( EQ 6 ) \\ {redundancy}^{″} = {redundancy}^{′} + I ( {x}_{j} ; {x}_{m - 1} ) , & ( EQ 7 ) \\ {score ( {x}_{j} )}_{m} = ( I ( {x}_{j} \text{:} c ) - \frac{{redundancy}^{″}}{m - 1} ) , & ( EQ 8 )\end{matrix}$$

where m−2 is the normalizing factor from the MRMR score determined based EQ 4 for the previous step m−1. For example, as the current step is the m-th step and the previous step is the (m−1)-th step, for the previous step, the MRMR score for each unselected feature xⱼ is:

$${}_{{x}_{j} ∈ X - {S}_{m - 2}} [ I ( {x}_{j} ; c ) - \frac{1}{m - 2} {\sum }_{{x}_{i} ∈ {S}_{m - 2}} I ( {x}_{j} ; {x}_{i} ) ] . \qquad ( EQ 9 )$$

The feature selection module 109 maintains the MRMR score, score(xⱼ), at each step (selection of a feature) for each un-selected feature xⱼ. Also, in EQ 6 redundancy′ is the redundancy score for the feature xⱼ at step m−1. In EQ 7 redundancy″ is the redundancy score for the feature xⱼ at step m.

Then, for every candidate feature being considered, the feature selection module 109 computes the redundancy score (redundancy′) of the feature in the previous step using the MRMR score for the same feature in the previous step, as shown in EQ 6. For each unselected feature, the feature selection module 109 computes the relevance score (redundancy″) of the feature to all the features in the SF pool as the sum of the recovered redundancy score (redundancy′) in the previous step and the redundancy I(xⱼ; xₘ₋₁) between the feature and the previously selected feature, as shown in EQ 7. This allows the MRMR score for a given feature xⱼ at step m to be rewritten as EQ 8 above:

$${score ( {x}_{j} )}_{m} = ( I ( {x}_{j} \text{:} c ) - \frac{{redundancy}^{″}}{m - 1} ) .$$

The feature selection module then selects the feature that maximizes the relevance and in the meanwhile minimizes the redundancy. Once a feature is selected the feature selection module 109 removes the selected feature the UF pool and places it into the SF pool. This process is repeated until the number of features reaches the input feature number. The selected features are then outputted to a user, an application, etc.

It should be that in another embodiment, the DMRMR process discussed above is a transductive DMRMR (TDMRMR) feature selection mechanism. Transduction assumes a setting where test data points are available to the learning algorithms. Therefore the learning algorithms can be more specific in that they can learn not only from the training data set, but also from the test data set. In this embodiment, the feature selection module 109 receives as input a set of training samples, each including a set of features (x^{training}) and a class/target value c. The feature selection module 109 also receives a set of test samples, each including only the same set of features(x^{test}) as the training samples with target values missing. The number of features to be selected is also received as input by the feature selection module 109.

Based on the above inputs, the feature selection module 109 transductively selects a set of features from the feature space that includes training data and test data based on the following:

$${max}_{{x}_{j} ∈ X - {S}_{m - 1}} [ \begin{matrix}I ( {x}_{j}^{training} ; {c}^{training} ) - \\ \frac{1}{m - 1} {\sum }_{{x}_{i} ∈ {S}_{m - 1}} I ( {x}_{j}^{training + test} ; {x}_{i}^{training + test} )\end{matrix} ] \qquad ( EQ 10 )$$

where the Minimum Redundancy component

$$\frac{1}{m - 1} {\sum }_{{x}_{i} ∈ {S}_{m - 1}} I ( {x}_{j}^{training + test} ; {x}_{i}^{training + test} )$$

can be rewritten as

$$\frac{{redundancy}^{″}}{m - 1}$$

for a given feature based on EQs 6, 7, and 8 above, where both features from the training dataset ad test sample set are considered. A more detailed discussion on transductive MRMR is given in the commonly owned patent application U.S. Ser. No. 13/745,930 entitled “Transductive Feature Selection With Maximum-Relevancy and Minimum-Redundancy Criteria”, filed on Jan. 21, 2013 which is hereby incorporated by reference in its entirety.

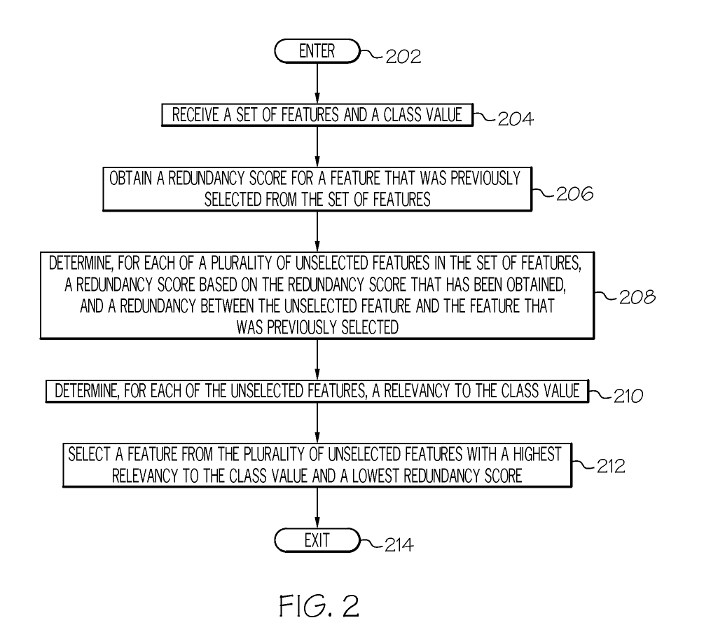

FIG. 2 is an operational flow diagram illustrating one example of an overall process for selecting features from a feature space. The operational flow diagram begins at step 2 and flows directly to step 204. The feature selection module 109, at step 204, receives a set of features and a class value. The feature selection module 109, at step 206, obtains a redundancy score for a feature that was previously selected from the set of features. The feature selection module 109, at step 208, determines a redundancy score for each of a plurality of unselected features in the set of features, based on the redundancy score that has been obtained, and a redundancy between the unselected feature and the feature that was previously selected. The feature selection module 109, at step 210, determines a relevance to the class value for each of the unselected features. feature selection module 109, at step 212, selects a feature from the plurality of unselected features with a highest relevance to the class value and a lowest redundancy score is selected. The above process is repeated until a given number of features have been selected. The control flow exits at step 214.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been discussed above with reference to flowchart illustrations and/or block diagrams of methods, apparatus (systems) and computer program products according to various embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An information processing system for selecting features from a feature space, the information processing comprising:
a memory;
a processor communicatively coupled to the memory; and
a feature selection module communicatively coupled to the memory and the processor, wherein the feature selection module is configured to perform a method comprising:
receiving, by a processor, a set of features and a class value;
obtaining a redundancy score for a feature that was previously selected from the set of features;
determining, for each of a plurality of unselected features in the set of features, a redundancy score based on the redundancy score that has been obtained, and a redundancy between the unselected feature and the feature that was previously selected;
determining, for each of the unselected features, a relevance to the class value; and
selecting a feature from the plurality of unselected features with a highest relevance to the class value and a lowest redundancy score.

2. The information processing system of claim 1, wherein the redundancy score for the feature that was previously selected from the set of features is obtained based on:
redundancy′=(I(xⱼ:c)−score(xⱼ)ₘ₋₁)×(m−2), I(xⱼ:c), where redundancy′ is the redundancy score for the feature that was previously selected, I(xⱼ:c) is a relevance between feature xⱼ and the class value c based on mutual information I, score(xⱼ)ₘ₋₁ is a maximum-relevancy and minimum-redundancy (MRMR) score calculated for feature xⱼ at a previous step m−1, and m−2 is a normalizing factor for the previous step m−1.

3. The information processing system of claim 2, wherein score(xⱼ)ₘ₋₁ is determined based on:
$${}_{{x}_{j} ∈ X - {S}_{m - 2}} [ I ( {x}_{j} ; c ) - \frac{1}{m - 2} {\sum }_{{x}_{i} ∈ {S}_{m - 2}} I ( {x}_{j} ; {x}_{i} ) ] ,$$
where X is the set of features and x, is a feature in the set S of m−2 features,
wherein the redundancy score, for each of the plurality of unselected features in the set of features, is determined based on:
redundancy′=redundancy′+I(xⱼ; xₘ₋₁), where redundancy″ is the determined redundancy score, and xₘ₋₁ is a feature selected in the previous step m−1.

4. The information processing system of claim 1, wherein determining, for each of the unselected features, the relevance to the class value is based on mutual information between the unselected feature and the class value.

5. The information processing system of claim 1, wherein the receiving comprises:
receiving at least one training sample comprising the set of features and the class value; and
receiving at least one test sample comprising the set of features absent the class value.

6. The information processing system of claim 5, wherein the redundancy score, for each of a plurality of unselected features, is determined based on the at least one training sample and the at least one test sample, and
wherein the relevance determined, for each of the unselected features, is determined based on the at least one training sample.

7. A non-transitory computer program product for selecting features from a feature space, the computer program product comprising:
a storage medium readable by a processing circuit and storing instructions for execution by the processing circuit for performing a method comprising:
receiving, by a processor, a set of features and a class value;
obtaining a redundancy score for a feature that was previously selected from the set of features;
determining, for each of a plurality of unselected features in the set of features, a redundancy score based on the redundancy score that has been obtained, and a redundancy between the unselected feature and the feature that was previously selected;
determining, for each of the unselected features, a relevance to the class value; and
selecting a feature from the plurality of unselected features with a highest relevance to the class value and a lowest redundancy score.

8. The non-transitory computer program product of claim 7, wherein the redundancy score for the feature that was previously selected from the set of features is obtained based on:
redundancy′=(I(xⱼ:c)−score(xⱼ)ₘ₋₁)×(m−2), I(xⱼ:c), where redundancy′ is the redundancy score for the feature that was previously selected, I(xⱼ:c) is a relevance between feature xⱼ and the class value c based on mutual information I, score(xⱼ)ₘ₋₁ is a maximum-relevancy and minimum-redundancy (MRMR) score calculated for feature xⱼ at a previous step m−1, and m−2 is a normalizing factor for the previous step m−1.

9. The non-transitory computer program product of claim 8, wherein score(xⱼ)ₘ₋₁ is determined based on:
$${}_{{x}_{j} ∈ X - {S}_{m - 2}} [ I ( {x}_{j} ; c ) - \frac{1}{m - 2} {\sum }_{{x}_{i} ∈ {S}_{m - 2}} I ( {x}_{j} ; {x}_{i} ) ] ,$$
where X is the set of features and xᵢ is a feature in the set S of m−2 features.

10. The non-transitory computer program product of claim 9, wherein the redundancy score, for each of the plurality of unselected features in the set of features, is determined based on:
redundancy′=redundancy′+I(xⱼ; xₘ₋₁), where redundancy″ is the determined redundancy score, and xₘ₋₁ is a feature selected in the previous step m−1.

11. The non-transitory computer program product of claim 7, wherein determining, for each of the unselected features, the relevance to the class value is based on mutual information between the unselected feature and the class value.

12. The non-transitory computer program product of claim 7, wherein the receiving comprises:
receiving at least one training sample comprising the set of features and the class value; and
receiving at least one test sample comprising the set of features absent the class value.

13. The non-transitory computer program product of claim 12, wherein the redundancy score, for each of a plurality of unselected features, is determined based on the at least one training sample and the at least one test sample, and
wherein the relevance determined, for each of the unselected features, is determined based on the at least one training sample.
